(19) United States
(12) Patent Application Publication
(10) Pub. No.: US 2025/0135794 A1
(43) Pub. Date: May 1, 2025

(54) ACCOMMODATION DEVICE AND LIQUID EJECTION APPARATUS

(71) Applicant: SEIKO EPSON CORPORATION, Tokyo (JP)

(72) Inventors: Akira YAMAGISHI, SHIOJIRI-SHI (JP); Hiroyuki NAKAMURA, SHIOJIRI-SHI (JP)

(21) Appl. No.: 18/925,167

(22) Filed: Oct. 24, 2024

(30) Foreign Application Priority Data
Oct. 27, 2023 (JP) 2023-184503

(51) Int. Cl. B41J 29/02; B41J 2/17

(52) U.S. Cl. CPC B41J 29/02; B41J 2/1721

(57) ABSTRACT

An accommodation device includes a housing in which a mounting port is open, a main body unit positioned in the housing, a mounting unit mounted in the housing, a coupling body coupled to the main body unit and the mounting unit, and a contact unit configured to contact the mounting unit, wherein the mounting unit is configured to move in one direction from an inside of the housing to an outside of the housing through the mounting port, and the contact unit contacts the mounting unit when the mounting unit mounted in the housing moves in the one direction.

The present application is based on, and claims priority from JP Application Serial Number 2023-184503, filed Oct. 27, 2023, the disclosure of which is hereby incorporated by reference herein in its entirety.

### BACKGROUND

### 1. Technical Field

The present disclosure relates to an accommodation device and a liquid ejection apparatus.

### 2. Related Art

Hitherto, there has been known an accommodation device including a housing, a main body unit that is positioned in the housing, a mounting unit that is mounted in the housing, and a coupling body that is coupled to the main body unit and the mounting unit. For example, as one example of an accommodation device, JP-A-2022-124597 describes a liquid ejection apparatus including an ejection unit that is positioned in a housing, a mounting unit that is mounted in the housing, and a tube that is coupled to the ejection unit and the mounting unit. In the liquid ejection apparatus, the mounting unit can be detached from the housing by removing the coupling body.

In such an accommodation device, there may be a risk that the mounting unit is detached from the housing while the coupling body is coupled to the main body unit and the mounting unit. In such a case, there may be a risk of damaging the coupling body.

### SUMMARY

In order to solve the above-mentioned problem, an accommodation device includes a housing in which a mounting port is open, a main body unit positioned in the housing, a mounting unit mounted in the housing, a coupling body coupled to the main body unit and the mounting unit, and a contact unit configured to contact the mounting unit, wherein the mounting unit is configured to move in one direction from an inside of the housing to an outside of the housing through the mounting port, and the contact unit contacts the mounting unit when the mounting unit mounted in the housing moves in the one direction.

In order to solve the above-mentioned problem, a liquid ejection apparatus includes the accommodation device described above, wherein the accommodation device includes a guide unit configured to guide the mounting unit when the mounting unit moves in the one direction, the mounting unit includes a guide body that is guided by the guide unit, the guide unit includes a restricting portion that restricts the mounting unit from moving upward when the mounting unit is at a first position, and an allowing portion that allows the mounting unit to move upward when the mounting unit is at a second position, the first position is a position at which the mounting unit is mounted in the housing, the second position is a position at which the mounting unit contacts the contact unit, a vertical distance between the guide body and the allowing portion when the mounting unit is at the second position is larger than a vertical distance required for the mounting unit to overcome the contact unit, the main body unit includes an ejection unit including a nozzle surface in which a nozzle is open and being configured to eject a liquid from the nozzle, a maintenance unit configured to perform maintenance for the ejection unit, and a gutter through which a liquid flows from the maintenance unit, the mounting unit includes a reception tray configured to receive a liquid, and a distal end of the gutter overlaps with the reception tray as viewed in a vertical direction.

In order to solve the above-mentioned problem, a liquid ejection apparatus includes the accommodation device described above, wherein the contact unit includes a guide unit configured to guide the mounting unit when the mounting unit moves in the one direction, the mounting unit includes a guide body that is guided by the guide unit, the guide unit includes a restricting portion that restricts the mounting unit from moving upward when the mounting unit is at a first position, and an allowing portion that allows the mounting unit to move upward when the mounting unit is at a second position, the first position is a position at which the mounting unit is mounted in the housing, the second position is a position at which the mounting unit contacts the contact unit, a vertical distance between the guide body and the allowing portion when the mounting unit is at the second position is larger than a vertical distance required for the mounting unit to overcome the contact unit, the main body unit includes an ejection unit including a nozzle surface in which a nozzle is open and being configured to eject a liquid from the nozzle, a maintenance unit configured to perform maintenance for the ejection unit, and a gutter through which a liquid flows from the maintenance unit, the mounting unit includes a reception tray configured to receive a liquid, and a distal end of the gutter overlaps with the reception tray as viewed in a vertical direction.

### BRIEF DESCRIPTION OF THE DRAWINGS

FIG. 1 is a perspective view illustrating one example of a liquid ejection apparatus.

FIG. 2 is a perspective view of the liquid ejection apparatus acquired by removing a cover from FIG. 1.

FIG. 3 is a front view schematically illustrating one example of an accommodation device.

FIG. 4 is a perspective view of a mounting unit and a maintenance unit.

FIG. 5 is a perspective view as viewed from an angle different from FIG. 4.

FIG. 6 is a perspective view acquired by removing a storage unit and a waste liquid container from FIG. 4.

FIG. 7 is a perspective view acquired by removing the storage unit and the waste liquid container from FIG. 5.

FIG. 8 is a top view of the mounting unit at a first position.

FIG. 9 is a top view of the mounting unit at a second position.

FIG. 10 is a cross-sectional view taken along the line 10-10 of FIG. 8.

FIG. 11 is a cross-sectional view taken along the line 11-11 of FIG. 9.

FIG. 12 is a perspective view of a contact unit.

FIG. 13 is a top view of the maintenance unit at a contact position.

FIG. 14 is a top view of the maintenance unit at a retraction position.

FIG. 15 is a perspective view of a second coupling body.

### DESCRIPTION OF EMBODIMENTS

An embodiment of a liquid ejection apparatus including an accommodation device is described below with reference to the drawings. The liquid ejection apparatus is, for example, an ink jet-type printer that performs printing of an image such as characters and photographs on a medium such as a sheet and fabric by ejecting ink, which is an example of liquid.

### Liquid Ejection Apparatus

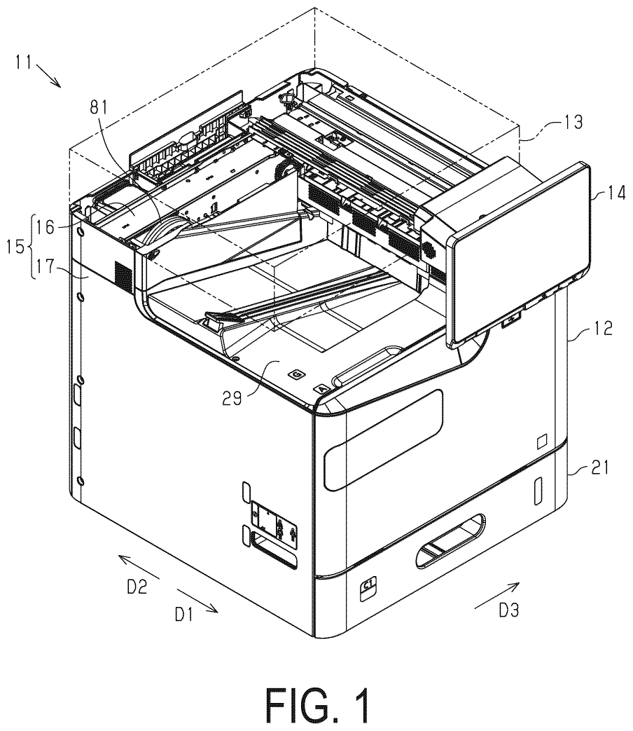

As illustrated in FIG. 1, a liquid ejection apparatus 11 includes an accommodation device 12. The accommodation device 12 accommodates various configurations. In one example, the accommodation device 12 is a printing device that prints an image. The accommodation device 12 is described later in detail.

The liquid ejection apparatus 11 may include a reading device 13. The reading device 13 is configured to read an image recorded on a document. The reading device 13 is a scanner. For example, the reading device 13 sequentially reads images by automatically feeding documents being set. The reading device 13 is mounted in the accommodation device 12. For example, the reading device 13 is mounted in the upper part of the accommodation device 12.

The liquid ejection apparatus 11 includes an operating unit 14. The operating unit 14 is an interface for a user to operate the liquid ejection apparatus 11. The operating unit 14 is, for example, a touch panel. The operating unit 14 may include a button, a lever, a switch, and the like. For example, the operating unit 14 is positioned in front of the accommodation device 12 and the reading device 13.

### Accommodation Device

The accommodation device 12 is described.

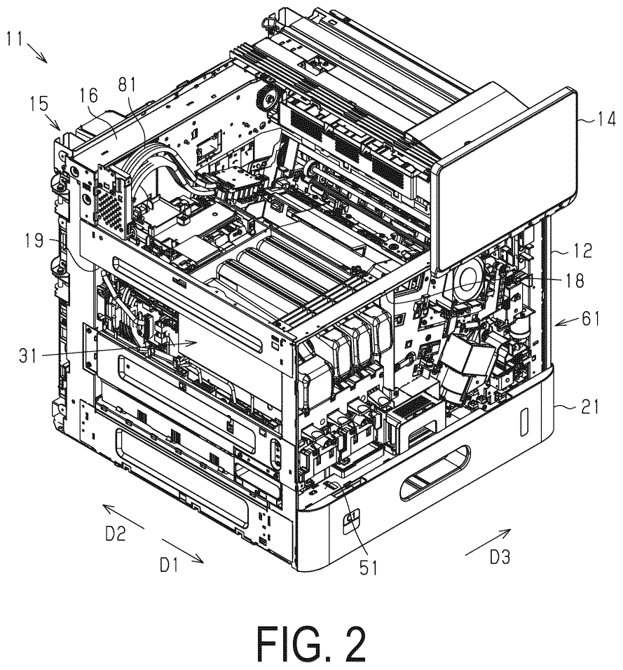

As illustrated in FIG. 1 and FIG. 2, the accommodation device 12 includes a housing 15. The housing 15 accommodates various configurations of the accommodation device 12. The housing 15 has a rectangular parallelepiped shape. The housing 15 has a depth, a width, and a height. The housing 15 includes a plurality of surfaces such as a front surface, a back surface, a side surface, and the like.

The housing 15 includes a frame 16. For example, the frame 16 is formed of metal.

The housing 15 includes one or more covers 17. The cover 17 is attached to the frame 16. For example, the cover 17 is formed of a resin. The cover 17 is attached to the frame 16 so as to cover the frame 16.

A mounting port 18 is open in the housing 15. In one example, the mounting port 18 is open in the front surface of the housing 15. The mounting port 18 is open to the front. The mounting port 18 may be open in the back surface or the side surface of the housing 15. In one example, the mounting port 18 is open in the frame 16. Thus, when the cover 17 is removed from the frame 16, the mounting port 18 is exposed. The mounting port 18 may be open in the cover 17. The housing 15 is configured so that a mounting unit 31, which is described later, can be detached from the housing 15 through the mounting port 18. The housing 15 is configured so that the mounting unit 31 can be mounted in the housing 15 through the mounting port 18.

A maintenance port 19 is open in the housing 15. In one example, the maintenance port 19 is open in the side surface of the housing 15. The maintenance port 19 is open to the side. the maintenance port 19 may be open in the front surface of the upper surface of the housing 15. In one example, the maintenance port 19 is open in the frame 16. Thus, when the cover 17 is removed from the frame 16, the maintenance port 19 is exposed. The maintenance port 19 may be open in the cover 17. The housing 15 is configured to access to a coupling body through the maintenance port 19. The maintenance port 19 may be an opening that is commonly shared with the mounting port 18. In other words, the housing 15 may be configured to access to the coupling body through the mounting port 18. The coupling body is coupled to the mounting unit 31. At least a part of the coupling body has flexibility. Thus, the coupling body can follow the mounting unit 31. The coupling body is described later.

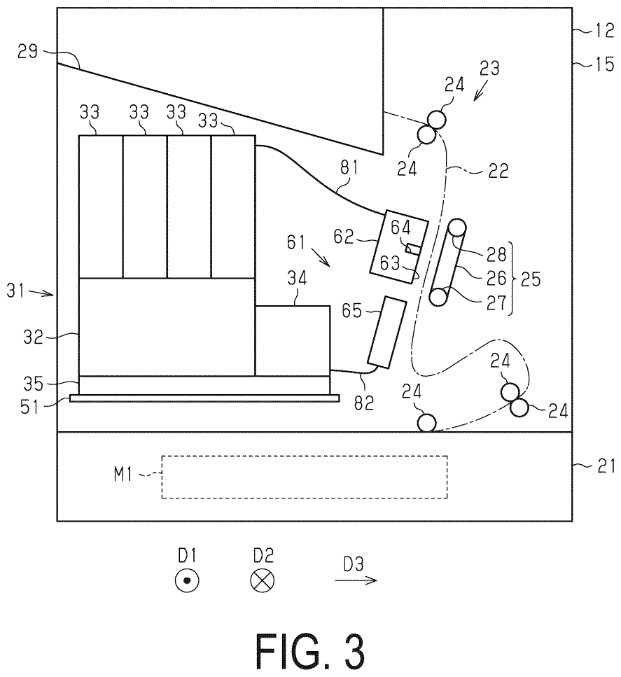

As illustrated in FIG. 3, the accommodation device 12 includes an accommodation unit 21. The accommodation unit 21 is configured to accommodate a medium M1. For example, the accommodation unit 21 accommodates the plurality of media M1 is a stacking state. The accommodation unit 21 is attached to the housing 15. The accommodation unit 21 is positioned at the lower part in the housing 15. In one example, the accommodation unit 21 is configured to be inserted to and extracted from the housing 15. For example, the accommodation unit 21 is a cassette. For example, the accommodation unit 21 can be inserted to and extracted from the front surface of the housing 15. A user can replenish the medium M1 on the accommodation unit 21 by drawing the accommodation unit 21 from the housing 15. The accommodation unit 21 is not limited to a cassette, and may be a tray.

The accommodation device 12 includes a transport path 22. The transport path 22 is a path in which the medium M1 is transported. The transport path 22 extends in the housing 15. The transport path 22 extends from the accommodation unit 21 to the outside of the housing 15. In a process of transporting the medium M1 in the transport path 22, an image is printed on the medium M1.

The accommodation device 12 includes a transport unit 23. The transport unit 23 is configured to transport the medium M1. The transport unit 23 transports the medium M1 accommodated in the accommodation unit 21. The transport unit 23 transports the medium M1 along the transport path 22. The transport unit 23 includes one or more rollers 24. In one example, the transport unit 23 includes a plurality of rollers 24. The plurality of rollers 24 are positioned along the transport path 22. Each of the plurality of rollers 24 rotates to transport the medium M1.

The accommodation device 12 includes a support unit 25. The support unit 25 is configured to support the medium M1. The support unit 25 supports the medium M1 being transported from the accommodation unit 21. The support unit 25 supports the medium M1 being transported in the transport path 22. In one example, the support unit 25 supports the medium M1 while being in an oblique posture with respect to the horizontal plane. The support unit 25 attracts and supports the medium M1. With this, the posture of the medium M1 is stabilized. The support unit 25 may support the medium M1 while being in a horizontal posture.

The support unit 25 may be configured to transport the medium M1. In one example, the support unit 25 includes a transport belt 26, a first pulley 27, and a second pulley 28. The transport belt 26 is wound around the first pulley 27 and the second pulley 28. For example, the transport belt 26 attracts the medium M1 by static electricity. With this, the transport belt 26 supports the medium M1. For example, the transport belt 26 may be configured to attract the medium M1 through suction by a negative pressure. When the first pulley 27 and the second pulley 28 rotate, the transport belt 26 rotates. As a result, the medium M1 supported on the transport belt 26 is transported. For example, the transport belt 26 transports the medium M1 obliquely upward. The support unit 25 may be a simply-structured support table.

The accommodation device 12 includes a stacker 29. The stacker 29 receives the medium M1 discharged to the outside of the housing 15 through the transport path 22. On the stacker 29, the medium M1 on which an image is printed is stacked. The stacker 29 is attached to the housing 15.

The accommodation device 12 includes a main body unit 61. The main body unit 61 is positioned in the housing 15. The main body unit 61 is coupled to the coupling body. The main body unit 61 is couple to the mounting unit 31 via the coupling body. The main body unit 61 is described later.

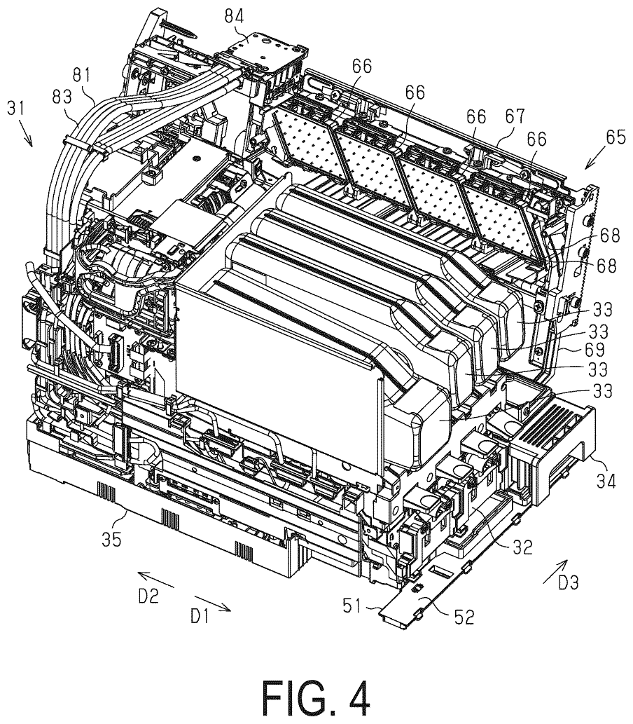

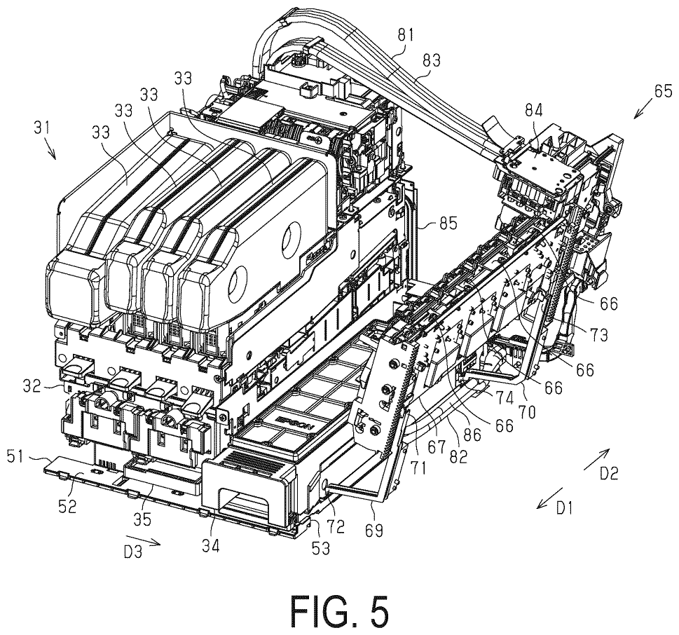

As illustrated in FIG. 4 and FIG. 5, the accommodation device 12 includes the mounting unit 31. The mounting unit 31 is mounted in the housing 15. The mounting unit 31 is attached to and detached from the housing 15 through the mounting port 18. In one example, the mounting unit 31 is inserted to and extracted from the front surface of the housing 15.

The mounting unit 31 is configured to move in one direction. The one direction is a direction from the inside of the housing 15 to the outside of the housing 15 through the mounting port 18. The mounting unit 31 is detached from the housing 15 through the mounting port 18 by moving in the one direction. In one example, the mounting unit 31 is configured to move in a first direction D1. The first direction D1 is a direction from the back side to the front side of the housing 15.

The mounting unit 31 is configured to move in an opposite direction. The opposite direction is a direction opposite to the one direction. The opposite direction is a direction from the outside of the housing 15 to the inside of the housing 15 through the mounting port 18. The mounting unit 31 is mounted in the housing 15 through the mounting port 18 by moving in the opposite direction. In one example, the mounting unit 31 is configured to move in a second direction D2. The second direction D2 is a direction from the front side to the back side of the housing 15.

The mounting unit 31 includes a storage unit 32. The storage unit 32 is configured to store a liquid. The storage unit 32 stores a liquid supplied from a liquid container 33, which is described later. The storage unit 32 is coupled to the coupling body. The liquid is supplied from the storage unit 32 to the main body unit 61 via the coupling body.

One or more liquid containers 33 are mounted in the mounting unit 31. In one example, four liquid containers 33 are mounted in the mounting unit 31. The liquid container 33 is mounted in the storage unit 32. With this, the liquid is supplied from the liquid container 33 to the storage unit 32. The liquid container 33 is positioned above the storage unit 32.

The four liquid containers 33 are arrayed in a third direction D3. The third direction D3 is a direction different from the first direction D1 and the second direction D2. The third direction D3 is a direction different from the vertical direction. In one example, the third direction D3 is a direction from the outside of the housing 15 to the inside of the housing 15 through the maintenance port 19.

The mounting unit 31 may include a waste liquid container 34. The waste liquid container 34 contains a waste liquid. The waste liquid container 34 is coupled to the coupling body. The waste liquid container 34 is coupled to the main body unit 61 via the coupling body. The waste liquid container 34 collects the liquid discharged from the main body unit 61. The waste liquid container 34 is arrayed with the storage unit 32 in the third direction D3. In one example, the storage unit 32 and the waste liquid container 34 are arrayed in the third direction D3 in the stated order.

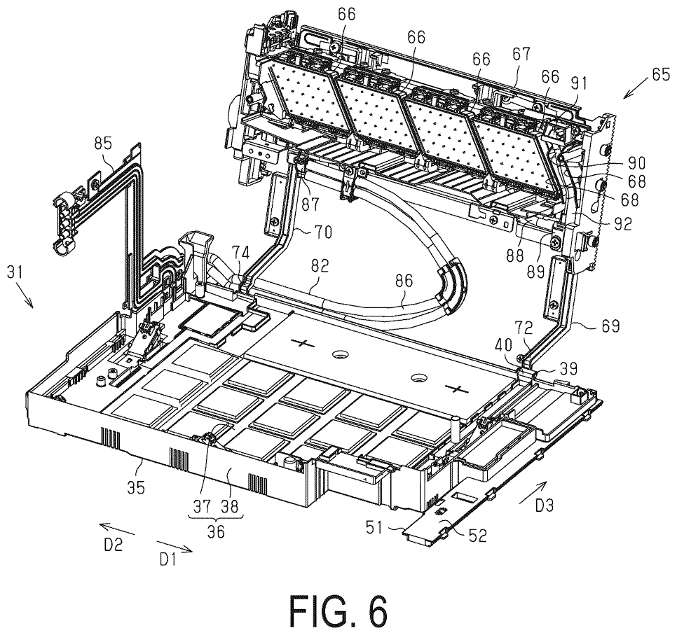

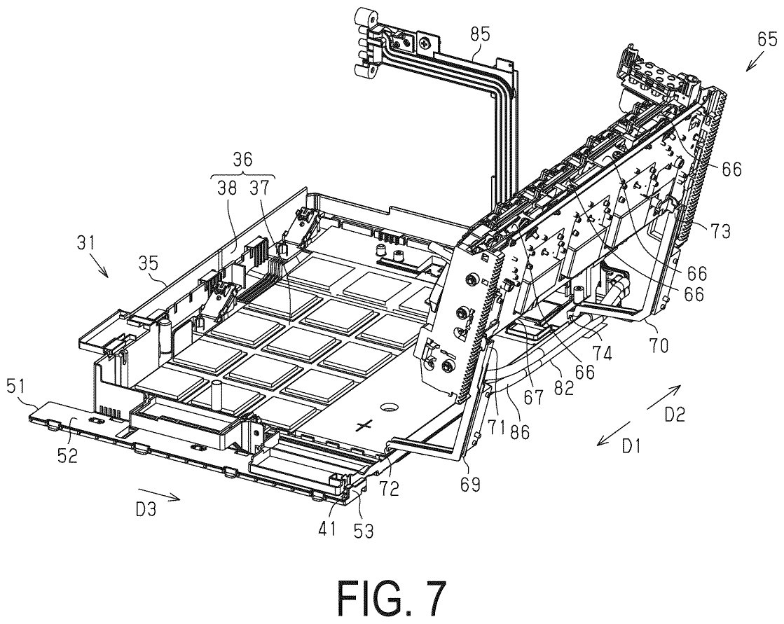

As illustrated in FIG. 6 and FIG. 7, the mounting unit 31 includes a reception tray 35. The reception tray 35 receives a liquid. In the mounting unit 31, there may be a risk that the liquid leaks or drips from the storage unit 32, the liquid container 33, the waste liquid container 34, and the like. The reception tray 35 receives such a liquid. The reception tray 35 is positioned below the storage unit 32 and the waste liquid container 34. As viewed in the vertical direction, the reception tray 35 is positioned to overlap with the storage unit 32, the liquid container 33, and the waste liquid container 34.

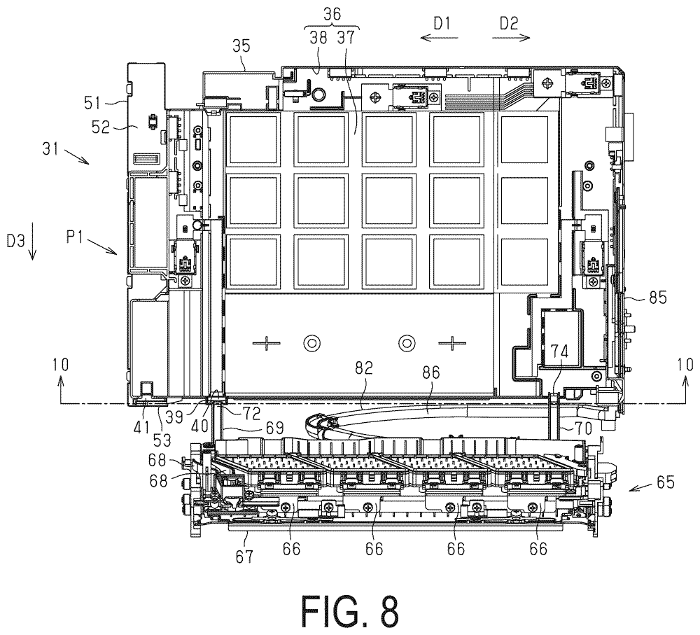

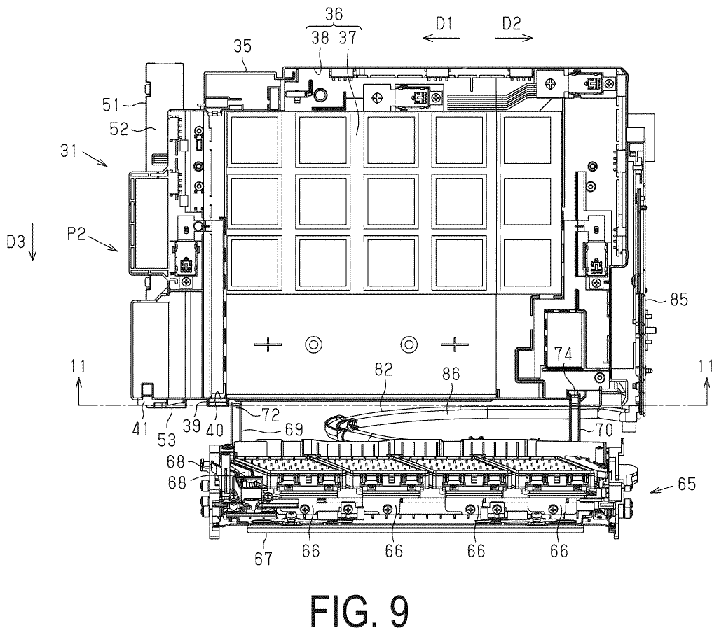

As illustrated in FIG. 8 and FIG. 9, the reception tray 35 includes a main tray 36. The main tray 36 is a part that receives the liquid from the storage unit 32, the liquid container 33, the waste liquid container 34, and the like. The main tray 36 is positioned directly below the storage unit 32 and the waste liquid container 34.

The main tray 36 includes a reception wall 37 and a peripheral wall 38. The reception wall 37 is a wall that receives the liquid. The reception wall 37 is a bottom wall of the main tray 36. The peripheral wall 38 extends from the reception wall 37. Specifically, the peripheral wall 38 extends from the peripheral edge of the reception wall 37. The peripheral wall 38 is a side wall of the main tray 36.

The reception tray 35 includes a sub tray 39. The sub tray 39 is continuous with the main tray 36. The sub tray 39 projects from the main tray 36. The sub tray 39 includes a projection wall 40. The projection wall 40 extends from the peripheral wall 38 in a direction different from the one direction and the vertical direction. In one example, the projection wall 40 extends in the third direction D3 from the peripheral wall 38. Specifically, the projection wall 40 extends in the third direction D3 from the outer circumferential surface of the peripheral wall 38. Due to the sub tray 39, an area of the reception tray 35 that can receive the liquid can be increased. The sub tray 39 receives the liquid from the main body unit 61. The liquid received by the sub tray 39 flows to the main tray 36.

The mounting unit 31 includes a guide body 41. When the mounting unit 31 moves in the first direction D1, the guide body 41 is guided by a guide unit 53, which is described later. When the mounting unit 31 is detached, the guide body 41 is guided by the guide unit 53. When the mounting unit 31 moves in the second direction D2, in other words, the mounting unit 31 is mounted in the housing 15, the guide body 41 may be guided by the guide unit 53.

The guide body 41 is a protrusion. The guide body 41 projects from the reception tray 35. In one example, the guide body 41 projects from the main tray 36. The guide body 41 projects in the third direction D3 from the peripheral wall 38. Specifically, the guide body 41 projects from the outer circumferential surface of the peripheral wall 38 in the third direction D3. The guide body 41 is arrayed with the sub tray 39 in the first direction D1. The sub tray 39 and the guide body 41 are arrayed in the first direction D1 in the stated order.

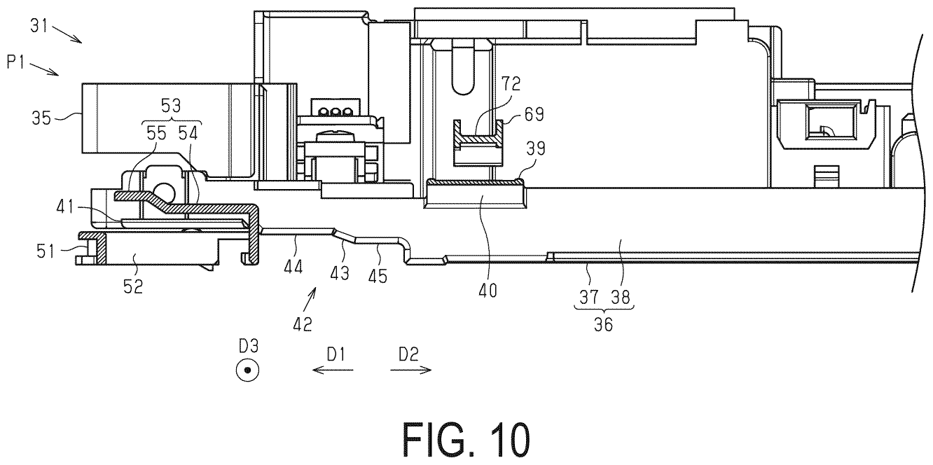

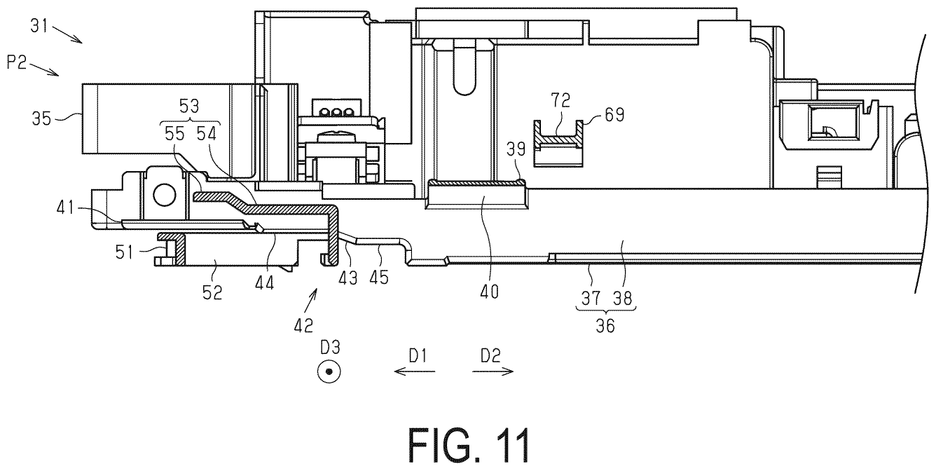

As illustrated in FIG. 10 and FIG. 11, the mounting unit 31 includes the protruding portion 42. When the mounting unit 31 moves in the first direction D1, the protruding portion 42 contacts a contact unit 51, which is described later. Specifically, when the mounting unit 31 mounted in the housing 15 is detached from the housing 15, the protruding portion 42 contacts the contact unit 51. When the protruding portion 42 contacts the contact unit 51, the mounting unit 31 is restricted from moving in the first direction D1. In one example, the reception tray 35 includes the protruding portion 42. The protruding portion 42 is at the bottom of the reception tray 35. For example, the protruding portion 42 is a level difference formed on the reception tray 35.

The protruding portion 42 includes a restricting surface 43. When the restricting surface 43 contacts the contact unit 51, the mounting unit 31 is restricted from moving in the first direction D1. The restricting surface 43 forms the bottom surface of the mounting unit 31. In one example, the restricting surface 43 forms the bottom surface of the reception tray 35. Specifically, the restricting surface 43 forms the bottom surface of the main tray 36.

The protruding portion 42 includes a first surface 44 and a second surface 45, in addition to the restricting surface 43. The first surface 44 and the second surface 45 form the bottom surface of the reception tray 35. Specifically, the first surface 44 and the second surface 45 form the bottom surface of the main tray 36. The first surface 44 and the second surface 45 has widths in the first direction D1 and the third direction D3. The first surface 44, the restricting surface 43, and the second surface 45 are arrayed in the second direction D2 in the stated order. The second surface 45 is positioned lower than the first surface 44. The restricting surface 43 is continuous with the first surface 44 and the second surface 45. The restricting surface 43 is inclined with respect to the first surface 44 and the second surface 45. The restricting surface 43 may be vertical to the first surface 44 and the second surface 45. The restricting surface 43, the first surface 44, and the second surface 45 form a level difference on the reception tray 35.

The mounting unit 31 is displaced between a first position P1 and a second position P2 by moving in the first direction D1 and the second direction D2. The first position P1 is a position at which the mounting unit 31 is mounted in the housing 15. In other words, the first position P1 is a position at which the mounting unit 31 is pushed into the housing 15. The second position P2 is a position at which the mounting unit 31 contacts the contact unit 51. In one example, the second position P2 is a position at which the protruding portion 42 contacts the contact unit 51. Specifically, the second position P2 is a position at which the restricting surface 43 contacts the contact unit 51. In other words, the second position P2 is a position at which the mounting unit 31 is restricted from moving in the first direction D1. The second position P2 is a position shifted in the first direction D1 from the first position P1. The mounting unit 31 illustrated in FIG. 10 is at the first position P1. The mounting unit 31 illustrated in FIG. 11 is at the second position P2.

While contacting with the contact unit 51, the mounting unit 31 is at such a position that the coupling body is removable from at least one of the main body unit 61 and the mounting unit 31. In other words, the second position P2 is a position at which the coupling body can be removed. At the second position P2, the mounting unit 31 is slightly drawn out in the first direction D1. With this, a space is generated behind the mounting unit 31. In one example, by accessing to the space through the maintenance port 19, the coupling body is removed.

In the mounting unit 31, while the coupling body is still coupled, the coupling body is sometimes detached from the housing 15. For example, a user sometimes forgets to remove the coupling body. In this case, when the coupling body is pulled, there may be a risk of damaging the coupling body. Thus, the coupling body may be removed from at least one of the mounting unit 31 and the main body unit 61 before the mounting unit 31 is detached from the housing 15. In other words, the coupling body may be removed from the mounting unit 31 or the main body unit 61, or both of them before the mounting unit 31 is detached from the housing 15.

The accommodation device 12 includes the contact unit 51. When the mounting unit 31 mounted in the housing 15 moves in the first direction D1, the contact unit 51 contacts the mounting unit 31. In one example, when the mounting unit 31 moves in the first direction D1, the contact unit 51 contacts the protruding portion 42. Specifically, when the mounting unit 31 moves in the first direction D1, the contact unit 51 contacts the restricting surface 43. The contact unit 51 contacts the mounting unit 31 at the second position P2.

When the contact unit 51 contacts the restricting surface 43, the mounting unit 31 is restricted from moving in the first direction D1. When the mounting unit 31 is detached from the housing 15, the contact unit 51 contacts the restricting surface 43, thereby generating resistance. When the mounting unit 31 is detached from the first position P1, the mounting unit 31 is temporarily stopped at the second position P2 due to resistance. Thus, a risk that the mounting unit 31 is detached from the housing 15 only by moving in the first direction D1 is low. When resistance is generated while detaching the mounting unit 31, a user can attempt to remove the coupling body. Thus, a risk that the mounting unit 31 is detached from the housing 15 while the coupling body is coupled is suppressed. Further, when resistance is generated while detaching the mounting unit 31, a risk that the mounting unit 31 is drawn out forcefully in the first direction D1 is suppressed. Therefore, a risk that a significant tension acts on the coupling body is suppressed. After the coupling body is removed, the mounting unit 31 rides over the contact unit 51. With this, the mounting unit 31 detached from to the housing 15.

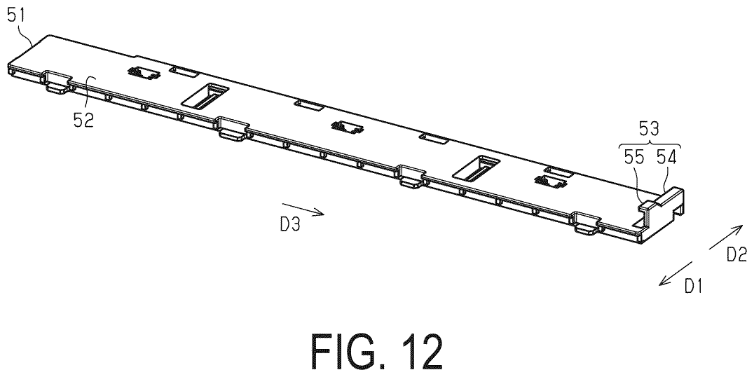

As illustrated in FIG. 12, the contact unit 51 includes a contact plate 52. The contact plate 52 is a plate extending in the third direction D3. The contact plate 52 is attached to the housing 15. When the mounting unit 31 is detached from the housing 15, the contact plate 52 contacts the protruding portion 42. When the mounting unit 31 is mounted in the housing 15, the contact plate 52 may contact the protruding portion 42. When the mounting unit 31 is detached from the housing 15, the contact plate 52 contacts the restricting surface 43. Specifically, when the mounting unit 31 detached, the contact plate 52 contacts sequentially with the first surface 44, the restricting surface 43, and the second surface 45 in the stated order. As a result, the mounting unit 31 rides over the contact plate 52.

While the mounting unit 31 is mounted in the housing 15, the protruding portion 42 does not contact the contact plate 52. In other words, while the mounting unit 31 is at the first position P1, the first surface 44 does not contact the contact plate 52. When the mounting unit 31 moves in the first direction D1 from the first position P1, the first surface 44 contacts the contact plate 52. Specifically, the contact plate 52 is positioned on the first surface 44. When the mounting unit 31 further moves in the first direction D1, the restricting surface 43 contacts the contact plate 52. In other words, the mounting unit 31 is displaced to the second position P2. When the mounting unit 31 is at the second position P2, the mounting unit 31 is restricted from moving in the first direction D1. In this state, a user moves the mounting unit 31 in the first direction D1 while lifting the mounting unit 31. With this, the protruding portion 42 rides over the contact plate 52. As a result, the second surface 45 contacts the contact plate 52. Specifically, the contact plate 52 is positioned on the second surface 45. When the mounting unit 31 further moves in the first direction D1, the mounting unit 31 detached from to the housing 15. In this manner, when the mounting unit 31 is detached, it is required to lift the mounting unit 31 in the middle of moving in the first direction D1.

The accommodation device 12 includes the guide unit 53. The guide unit 53 is configured to guide the mounting unit 31. Specifically, the guide unit 53 guides the guide body 41. When the mounting unit 31 is detached from the housing 15, the guide unit 53 guides the mounting unit 31. When the mounting unit 31 is mounted in the housing 15, the guide unit 53 may also guide the mounting unit 31. In one example, the mounting unit 31 is attached to and detached from the housing 15, the guide unit 53 guides the mounting unit 31.

The guide unit 53 extends from the contact plate 52. Specifically, the guide unit 53 extends from the distal end of the contact plate 52 in the third direction D3. It can also be understood that the contact unit 51 includes the guide unit 53. The guide unit 53 may be configured independently from the contact unit 51. In other words, the accommodation device 12 may include the guide unit 53 independently from the contact unit 51.

The guide unit 53 includes a restricting portion 54 and an allowing portion 55. The restricting portion 54 is a portion that restricts the mounting unit 31 from moving upward. The allowing portion 55 is a portion that allows the mounting unit 31 to move upward. For example, the restricting portion 54 extends upward from the contact plate 52, and then extends in the first direction D1. For example, the allowing portion 55 extends upward from the restricting portion 54 and in the first direction D1. In the guide unit 53, a groove along which the guide body 41 is guided by the restricting portion 54, the allowing portion 55, and the contact plate 52 is formed.

The mounting unit 31 may be lifted while the restricting surface 43 contacts the contact unit 51. For example, when the mounting unit 31 is lifted while the first surface 44 contacts the contact unit 51, there may be a risk that the contact unit 51 does not contact the restricting surface 43. In other words, there may be a risk that mounting unit 31 is detached from the housing 15 without restricting movement of the mounting unit 31 in the first direction D1. The guide unit 53 guides the guide body 41 to limit the timing at which the mounting unit 31 is lifted.

As illustrated in FIG. 10 and FIG. 11, the guide unit 53 is configured so that the restricting portion 54 is positioned above the guide body 41 while the mounting unit 31 is mounted in the housing 15. In other words, when the mounting unit 31 is at the first position P1, the restricting portion 54 is positioned above the guide body 41. When the mounting unit 31 is at the first position P1, the restricting portion 54 restricts the mounting unit 31 from moving upward. The guide unit 53 is configured so that the allowing portion 55 is positioned above the guide body 41 while the contact unit 51 contacts the restricting surface 43. In other words, when the mounting unit 31 is at the second position P2, the allowing portion 55 is positioned above the guide body 41. When the mounting unit 31 is at the second position P2, the allowing portion 55 allows the mounting unit 31 to move upward.

The vertical direction between the restricting portion 54 and the guide body 41 is smaller than the vertical direction between the allowing portion 55 and the guide body 41. In one example, the vertical direction between the restricting portion 54 and the contact plate 52 is smaller than the vertical direction between the allowing portion 55 and the contact plate 52. Thus, when the mounting unit 31 at the first position P1 moves upward, the guide body 41 easily contacts the restricting portion 54. When the restricting portion 54 contacts the guide body 41, the mounting unit 31 is restricted from moving upward. Therefore, at the first position P1, lifting of the mounting unit 31 is restricted. In contrast, even when the mounting unit 31 at the second position P2 moves upward, the guide body 41 is less likely to contact the allowing portion 55. Thus, at the second position P2, lifting of the mounting unit 31 is allowed.

The vertical direction between the restricting portion 54 and the guide body 41 is smaller than the distance required for the mounting unit 31 to overcome the contact unit 51. Specifically, the vertical direction between the restricting portion 54 and the guide body 41 is smaller than the vertical distance between the first surface 44 and the second surface 45. With this, a risk that the mounting unit 31 is detached from the housing 15 without the contact of the restricting surface 43 with the contact unit 51 is suppressed. The guide unit 53 guides the mounting unit 31 at the first position P1 in the first direction D1 by the restricting portion 54.

The vertical direction between the allowing portion 55 and the guide body 41 is larger than the distance required for the mounting unit 31 to overcome the contact unit 51. Specifically, the vertical direction between the allowing portion 55 and the guide body 41 is larger than the vertical distance between the first surface 44 and the second surface 45. With this, the mounting unit 31 can overcome the contact unit 51. The guide unit 53 guides the mounting unit 31 at the second position P2 upward by the allowing portion 55. Further, the guide unit 53 guides the mounting unit 31, which is lifted, in the first direction D1 by the allowing portion 55.

Next, the main body unit 61 is described.

As illustrated in FIG. 3, the main body unit 61 includes an ejection unit 62. The ejection unit 62 is configured to eject the liquid onto the medium M1. The ejection unit 62 prints an image on the medium M1 by ejecting the liquid onto the medium M1. The ejection unit 62 faces the support unit 25. The ejection unit 62 prints an image on the medium M1 supported on the support unit 25.

The ejection unit 62 includes a nozzle surface 63. In the nozzle surface 63, one or more nozzles 64 are open. The ejection unit 62 ejects the liquid from the nozzle 64. In one example, the ejection unit 62 is positioned so that the nozzle surface 63 is oblique with respect to the horizontal plane and the vertical plane. For example, the nozzle surface 63 faces obliquely downward.

The ejection unit 62 is elongated in the one direction. For example, the ejection unit 62 is elongated in the first direction D1. With this, the ejection unit 62 can eject the liquid over the width of the medium M1. In one example, the ejection unit 62 is a line head that can eject the liquid simultaneously over the width of the medium M1. The ejection unit 62 may be a serial head that ejects the liquid while performing scanning with respect to the medium M1.

The ejection unit 62 is configured to move in a direction vertical to the nozzle surface 63. The ejection unit 62 moves in this direction to approach or be away from the support unit 25.

The ejection unit 62 is coupled to the coupling body. The liquid is supplied from the storage unit 32 to the ejection unit 62 via the coupling body. The coupling body follows as the ejection unit 62 moves.

The main body unit 61 includes a maintenance unit 65. The maintenance unit 65 performs maintenance of the ejection unit 62. Specifically, the maintenance unit 65 performs maintenance of the ejection unit 62 by flushing, capping, cleaning, and the like. The flushing is an operation of appropriately ejecting the liquid from the nozzle 64 by the ejection unit 62. Through the flushing, clogging at the nozzle 64 is suppressed. The maintenance unit 65 receives the liquid by the flushing. The capping is an operation of moisturizing the nozzle 64. Through the capping, clogging of the nozzle 64 is suppressed. The maintenance unit 65 contacts the ejection unit 62 to form a space communicating with the nozzle 64. The cleaning is an operation of discharging the liquid from the nozzle 64. Through the cleaning, a foreign material is discharged with the liquid from the nozzle 64. The maintenance unit 65 performs suction to cause the nozzle 64 to discharge the liquid.

As illustrated in FIG. 4 and FIG. 5, the maintenance unit 65 includes one or more caps 66. In one example, the maintenance unit 65 includes a plurality of caps 66. The plurality of caps 66 are arrayed in the one direction. In one example, the plurality of caps 66 is arrayed in the elongation direction of the ejection unit 62.

The cap 66 contacts the ejection unit 62. In one example, the cap 66 contacts the nozzle surface 63. With this, the cap 66 performs the capping for the ejection unit 62. The cap 66 receives the liquid from the ejection unit 62. The cap 66 may receive the liquid ejected from the ejection unit 62 through the flushing, or may receive the liquid discharged from the ejection unit 62 through the cleaning.

The maintenance unit 65 includes a holder 67. The holder 67 holds the cap 66. The cap 66 is attached to the holder 67. The holder 67 sometimes receive the liquid leaking or dripping from the ejection unit 62, the cap 66, and the like.

The holder 67 may be configured to move in a direction vertical to the nozzle surface 63. The holder 67 may move in this direction to approach or be away from the ejection unit 62.

The holder 67 is configured to move between a contact position at which the cap 66 contacts the ejection unit 62 and a retraction position at which the cap 66 is retracted from the ejection unit 62. The contact position is a position between the ejection unit 62 and the support unit 25. The contact position is a position at which the cap 66 faces the ejection unit 62. At the contact position, the ejection unit 62 and the cap 66 approach each other, and thus the cap 66 contacts the ejection unit 62. The retraction position is a position retracted from a point between the ejection unit 62 and the support unit 25. In one example, the retraction position is a position lower than the contact position. When maintenance is performed for the ejection unit 62, the holder 67 moves to the contact position. The holder 67 may move between the contact position and the retraction position by a rack and a pinion or a ball screw.

The holder 67 is coupled to the coupling body. The cap 66 is coupled to the coupling body via the holder 67. Via the coupling body, the liquid is collected from the cap 66 to the waste liquid container 34. The coupling body follows as the holder 67 moves.

The holder 67 includes one or more guide plates 68. In one example, the holder 67 includes two guide plates 68. The guide plate 68 guides the coupling body. With this, the posture of the coupling body is stabilized. Further, the guide plate 68 guides the coupling body, and thus the coupling body easily follows the movement of the holder 67. For example, the guide plate 68 is positioned in the first direction D1 with respect to the cap 66.

The main body unit 61 includes one or more gutters. In one example, the main body unit 61 includes a first gutter 69 and a second gutter 70. For example, the second gutter 70 and the first gutter 69 are arrayed in the first direction D1 in the stated order. The gutter is configured so that the liquid flows from the maintenance unit 65. Specifically, the gutter extends so that the liquid flows from the maintenance unit 65 to the reception tray 35. Specifically, due to the gutter, the liquid flows from the holder 67 to the reception tray 35. Due to the gutter, the liquid received by the holder 67 flows to the reception tray 35. The gutter is attached to the housing 15. For example, the gutter is positioned so as to receive the liquid dripping from the holder 67. The gutter is positioned so that the liquid drips onto the reception tray 35.

The gutter includes a base end and a distal end. The first gutter 69 includes a first base end 71 and a first distal end 72. The second gutter 70 includes a second base end 73 and a second distal end 74. The gutter extends so that the liquid flows from the base end to the distal end. As viewed in the vertical direction, the base end overlaps with the holder 67. Specifically, as viewed in the vertical direction, the base end at least overlaps with at least the holder 67 at the contact position. When the holder 67 is at the retraction position, the gutter may receive the liquid onto the part between the base end and the distal end from the holder 67. As viewed in the vertical direction, the distal end overlaps with the reception tray 35. Specifically, when the mounting unit 31 at the first position P1 is viewed in the vertical direction, the distal end overlaps with the reception tray 35. When the mounting unit 31 at the second position P2 is viewed in the vertical direction, the distal end does not overlap with the reception tray 35.

As illustrated in FIG. 8, when the mounting unit 31 at the first position P1 is viewed in the vertical direction, the first distal end 72 overlaps with the projection wall 40. Thus, due to the first gutter 69, the liquid flows to the sub tray 39. When the mounting unit 31 at the first position P1 is viewed in the vertical direction, the second distal end 74 overlaps with the reception wall 37. Thus, due to the second gutter 70, the liquid flows to the main tray 36.

As illustrated in FIG. 9, when the mounting unit 31 at the second position P2 is viewed in the vertical direction, the first distal end 72 does not overlap with the projection wall 40. In other words, at the second position P2, the first distal end 72 does not overlap with the reception tray 35.

Specifically, when the mounting unit 31 at the second position P2 is viewed in the vertical direction, the first distal end 72 is positioned adjacent to the projection wall 40. When the mounting unit 31 at the second position P2 is viewed in the vertical direction, the second distal end 74 does not overlap with the reception wall 37. Specifically, when the mounting unit 31 at the second position P2 is viewed in the vertical direction, the second distal end 74 is positioned adjacent to the peripheral wall 38. With this, a risk that the mounting unit 31 lifted at the second position P2 interferes with the gutter is suppressed. In other words, a risk that the gutter inhibits the detachment of the mounting unit 31 is suppressed. Hypothetically, when the first gutter 69 extends so that the liquid flows to the main tray 36, the mounting unit 31 is displaced from the first position P1 to the second position P2. In such a case, the first distal end 72 is less likely to be retracted from the reception tray 35. In view of this, when the mounting unit 31 is displaced from the first position P1 to the second position P2, the first distal end 72 is easily retracted from the reception tray 35 because the first gutter 69 extends so that the liquid flows to the sub tray 39.

Next, the coupling body is described.

As illustrated in FIG. 3, the accommodation device 12 includes the coupling body. The coupling body is coupled to the main body unit 61 and the mounting unit 31. Due to the flexibility, the coupling body can follow the movement of the mounting unit 31 and follow the movement of the main body unit 61. In one example, the accommodation device 12 includes a first coupling body 81 and a second coupling body 82. The first coupling body 81 is coupled to the storage unit 32 and the ejection unit 62. The second coupling body 82 is coupled to the waste liquid container 34 and the maintenance unit 65. The first coupling body 81 and the second coupling body 82 form a flow path through which the liquid flows. For example, the coupling body includes a tube, a joint, and the like. The tube has flexibility.

As illustrate in FIG. 4 and FIG. 5, the first coupling body 81 includes a supply tube 83. The supply tube 83 is coupled to the storage unit 32. The supply tube 83 is coupled to the storage unit 32 behind the liquid container 33. The supply tube 83 extends from behind the liquid container 33. The supply tube 83 is curved in an arc shape and extends from the storage unit 32 to the ejection unit 62. This is because the supply tube 83 follows the movement of the ejection unit 62.

The first coupling body 81 includes a supply joint 84. The supply joint 84 is coupled to the ejection unit 62. For example, the supply joint 84 is attached to the housing 15. The supply joint 84 is coupled to the supply tube 83. The liquid is supplied from the storage unit 32 to the ejection unit 62 via the supply tube 83 and the supply joint 84.

The first coupling body 81 is removed from at least one of the mounting unit 31 and the main body unit 61 through the maintenance port 19. The supply tube 83 may be removed from the storage unit 32, or the supply joint 84 may be removed from the ejection unit 62. For example, the first coupling body 81 is removed through the maintenance port 19. The first coupling body 81 may be removed through the mounting port 18.

As illustrated in FIG. 6 and FIG. 7, the second coupling body 82 includes a flow path member 85. For example, the flow path member 85 is a member formed by welding a resin film, a resin cover, or the like to a resin base material in which a groove is formed. The flow path member 85 is positioned behind the mounting unit 31. The flow path member 85 is attached to the housing 15. For example, the flow path member 85 is coupled to the waste liquid container 34 via a tube, which is omitted in illustration.

The second coupling body 82 includes one or more waste liquid tubes and one or more waste liquid joints. For example, the second coupling body 82 includes two first waste liquid tubes 86, one first waste liquid joint 87, two second waste liquid tubes 88, one second waste liquid joint 89, two third waste liquid tubes 90, and one third waste liquid joint 91. The second coupling body 82 includes the two first waste liquid tubes 86, the two second waste liquid tubes 88, and the two third waste liquid tubes 90, and thus the flow path area of the second coupling body 82 is increased. With this, the liquid easily flows through the second coupling body 82.

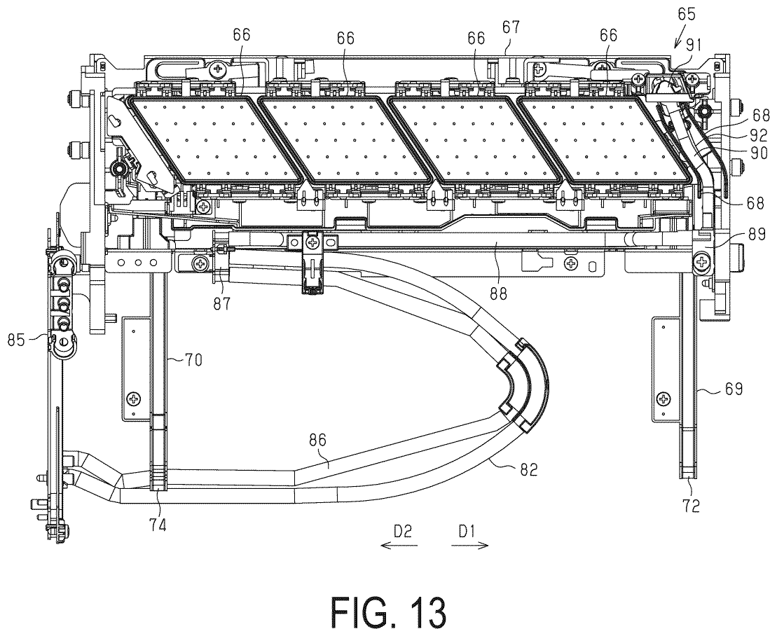

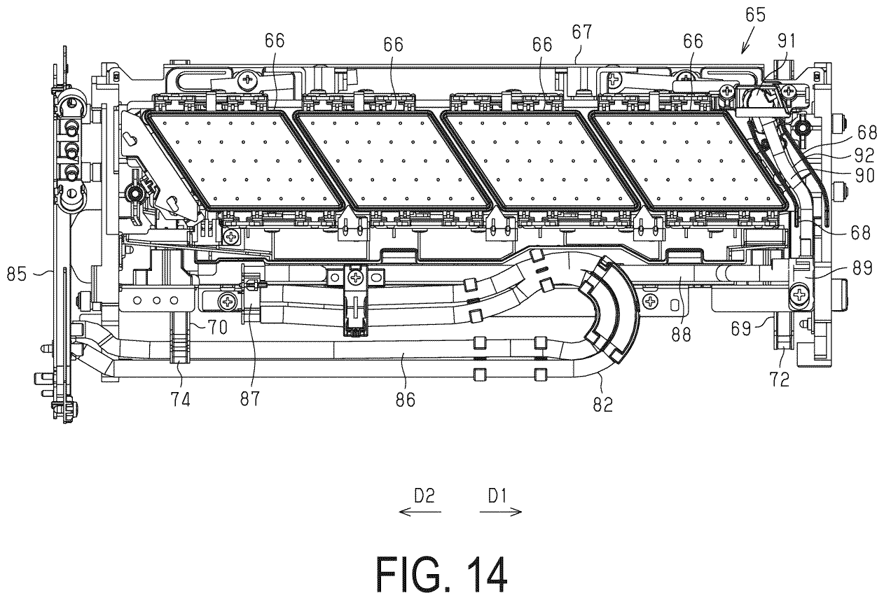

As illustrated in FIG. 13 and FIG. 14, the first waste liquid tube 86 are coupled to the flow path member 85 and the first waste liquid joint 87. The second waste liquid tube 88 is coupled to the first waste liquid joint 87 and the second waste liquid joint 89. The third waste liquid tube 90 is coupled to the second waste liquid joint 89 and the third waste liquid joint 91. The third waste liquid tube 90 is guided by the guide plate 68. The first waste liquid joint 87, the second waste liquid joint 89, and the third waste liquid joint 91 are attached to the holder 67. The third waste liquid joint 91 is coupled to the holder 67 so as to collect the liquid from the cap 66.

The two first waste liquid tubes 86 are curved in an arc shape and extend from the flow path member 85 to the first waste liquid joint 87. This is because the two first waste liquid tubes 86 follow the movement of the holder 67. The curvature of the first waste liquid tube 86 in a case in which the holder 67 is at the retraction position is larger than that in a case in which the holder 67 is at the contact position. the two first waste liquid tubes 86 being curved extend while being aligned. Thus, of the two first waste liquid tubes 86, the first waste liquid tube 86 positioned on the inner side and the first waste liquid tube 86 positioned on the outer side have different curvatures. Of the two first waste liquid tubes 86, the first waste liquid tube 86 positioned on the inner side is shorter than the first waste liquid tube 86 positioned on the outer side. With this, the two first waste liquid tubes 86 are easily accommodated in a predetermined space.

The second coupling body 82 is removed from at least one of the mounting unit 31 and the main body unit 61 through the maintenance port 19. The flow path member 85 may be removed from the waste liquid container 34, or the third waste liquid joint 91 may be removed from the holder 67. For example, the second coupling body 82 is removed through the maintenance port 19. The second coupling body 82 may be removed through the mounting port 18.

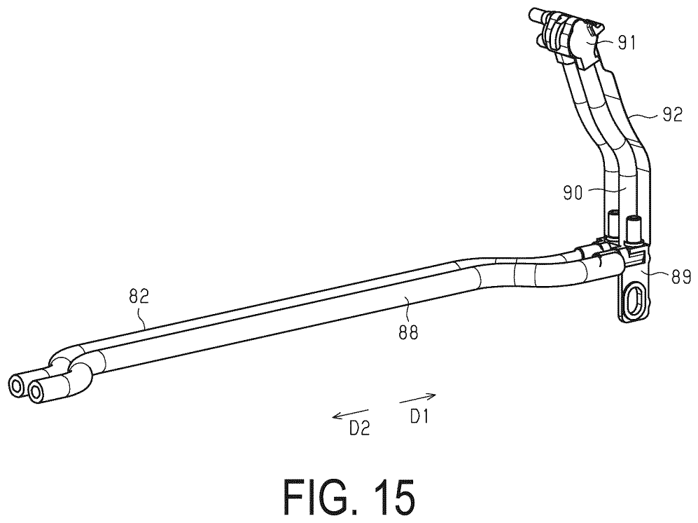

As illustrated in FIG. 15, the second coupling body 82 may include a band member 92. The band member 92 is a member that bundles the waste liquid joints with each other. In one example, the band member 92 is attached to the second waste liquid joint 89 and the third waste liquid joint 91. When a user removes the third waste liquid joint 91 from the holder 67, the third waste liquid joint 91 is forcefully extracted from the holder 67. In this case, when the third waste liquid joint 91 is forcefully lifted, there may be a risk that the third waste liquid tube 90 falls off from the third waste liquid joint 91 or the second waste liquid joint 89 falls off from the third waste liquid tube 90. In view of this, the band member 92 protects coupling between the third waste liquid joint 91 and the third waste liquid tube 90 and coupling between the third waste liquid tube 90 and the second waste liquid joint 89. Thus, a risk that the third waste liquid tube 90 falls off from the third waste liquid joint 91 or the second waste liquid joint 89 falls off from the third waste liquid tube 90 is suppressed.

### Operations and Effects

Next, operations and effects of the above-mentioned embodiment are described.
(1) When the mounting unit 31 mounted in the housing 15 moves in the first direction D1, the contact unit 51 contacts the mounting unit 31. According to the configuration described above, when the mounting unit 31 contacts the contact unit 51, the mounting unit 31 is restricted from moving in the first direction D1. Thus, a risk that the mounting unit 31 is detached from the housing 15 only by moving in the first direction D1 is suppressed. With this, a risk that the mounting unit 31 is detached from the housing 15 while the coupling body is coupled to the main body unit 61 and the mounting unit 31 is suppressed. Therefore, a risk of damaging the coupling body is suppressed.
(2) The mounting unit 31 includes the protruding portion 42 that contacts the contact unit 51 by moving in the first direction D1. The protruding portion 42 is positioned at the bottom of the mounting unit 31. According to the configuration described above, the mounting unit 31 can be restricted from moving in the first direction D1 with a simple configuration.
(3) While contacting with the contact unit 51, the mounting unit 31 is at such a position that the coupling body is removable from at least one of the main body unit 61 and the mounting unit 31. According to the configuration described above, in a process of removing the mounting unit 31, the coupling body can easily be removed.
(4) The guide unit 53 includes the restricting portion 54 and the allowing portion 55. The vertical distance between the guide body 41 and the allowing portion 55 when the mounting unit 31 is at the second position P2 is larger than the vertical distance for the mounting unit 31 to overcome the contact unit 51. According to the configuration described above, the guide unit 53 guides the mounting unit 31 at the first position P1 not to move upward, and guides the mounting unit 31 at the second position P2 to move upward. The mounting unit 31 moves upward to overcome the contact unit 51. With this, the mounting unit 31 detached from to the housing 15. In this manner, the guide unit 53 guides the mounting unit 31 to smoothly detach the mounting unit 31.
(5) As viewed in the vertical direction, the distal end of the gutter overlaps with the reception tray 35. According to the configuration described above, the liquid flows from the maintenance unit 65 to the reception tray 35 through the gutter. The liquid received onto the reception tray 35 can be collected by detaching the mounting unit 31.
(6) When the mounting unit 31 at the first position P1 is viewed in the vertical direction, the first distal end 72 overlaps with the projection wall 40. When the mounting unit 31 at the first position P1 is viewed in the vertical direction, the second distal end 74 overlaps with the reception wall 37. According to the configuration described above, when the mounting unit 31 is displaced from the first position P1 to the second position P2, the first gutter 69 and the second gutter 70 are easily retracted from the reception tray 35. Thus, when the mounting unit 31 is detached, a risk that the first gutter 69 and the second gutter 70 contact the reception tray 35 is suppressed.

### MODIFICATIONS

The above-mentioned embodiment may be modified as follows for implementation. The above-mentioned embodiment and the following modifications may be combined for implementation insofar as they are not technically inconsistent.
The accommodation device 12 may be applied to a device including the mounting unit 31 and the main body unit 61, other than the liquid ejection apparatus 11 . . . .
The coupling body is not limited to a tube, and may include wiring lines such as a flexible flat cable and a signal line.
The liquid ejected by the ejection unit 62 is not limited to ink, and may be, for example, a liquid material including particles of a functional material dispersed or mixed in liquid. For example, the ejection unit 62 may eject a liquid material including, in a dispersed or dissolved form, a material such as an electrode material or a pixel material used in manufacture of a liquid crystal display, an electroluminescent (EL) display, and a surface emitting display.

### TECHNICAL IDEAS

The following describes technical ideas and operational effects that are derived from the above-described embodiment and modifications.
(A) The accommodation device includes a housing in which a mounting port is open, a main body unit positioned in the housing, a mounting unit mounted in the housing, a coupling body coupled to the main body unit and the mounting unit, and a contact unit configured to contact the mounting unit, wherein the mounting unit is configured to move in one direction from an inside of the housing to an outside of the housing through the mounting port, and the contact unit contacts the mounting unit when the mounting unit mounted in the housing moves in the one direction. According to the configuration described above, when the mounting unit contacts the contact unit, the mounting unit is restricted from moving in the one direction. Thus, a risk that the mounting unit is detached from the housing only by moving in the one direction is suppressed. With this, a risk that the mounting unit is detached from the housing while the coupling body is coupled to the main body unit and the mounting unit is suppressed. Therefore, a risk of damaging the coupling body is suppressed.
(B) In the accommodation device described above, the mounting unit may include a protruding portion that contacts the contact unit by moving in the one direction, and the protruding portion may be at a bottom of the mounting unit. According to the configuration described above, the mounting unit can be restricted from moving in the one direction with a simple configuration.
(C) In the accommodation device described above, while contacting with the contact unit, the mounting unit may be at such a position that the coupling body is removable from at least one of the main body unit and the mounting unit. According to the configuration described above, in a process of removing the mounting unit, the coupling body can easily be removed.
(D) The accommodation device described above may include a guide unit configured to guide the mounting unit when the mounting unit moves in the one direction, wherein, the mounting unit may include a guide body that is guided by the guide unit, the guide unit may include a restricting portion that restricts the mounting unit from moving upward when the mounting unit is at a first position, and an allowing portion that allows the mounting unit to move upward when the mounting unit is at a second position, the first position may be a position at which the mounting unit is mounted in the housing, the second position may be a position at which the mounting unit contacts the contact unit, and a vertical distance between the guide body and the allowing portion when the mounting unit is at the second position may be larger than a vertical distance required for the mounting unit to overcome the contact unit. According to the configuration described above, the guide unit guides the mounting unit at the first position not to move upward, and guides the mounting unit at the second position to move upward. The mounting unit moves upward to overcome the contact unit. With this, the mounting unit is detached from the housing. In this manner, the guide unit guides the mounting unit to smoothly detach the mounting unit.
(E) In the accommodation device described above, the contact unit may include a guide unit configured to guide the mounting unit when the mounting unit moves in the one direction, the mounting unit may include a guide body that is guided by the guide unit, the guide unit may include a restricting portion that restricts the mounting unit from moving upward when the mounting unit is at a first position, and an allowing portion that allows the mounting unit to move upward when the mounting unit is at a second position, the first position may be a position at which the mounting unit is mounted in the housing, the second position may be a position at which the mounting unit contacts the contact unit, and a vertical distance between the guide body and the allowing portion when the mounting unit is at the second position may be larger than a vertical distance required for the mounting unit to overcome the contact unit. According to the configuration described above, the guide unit guides the mounting unit at the first position not to move upward, and guides the mounting unit at the second position to move upward. The mounting unit moves upward to overcome the contact unit. With this, the mounting unit is detached from the housing. In this manner, the guide unit guides the mounting unit to smoothly detach the mounting unit.
(F) The liquid ejection apparatus includes the accommodation device described above, wherein the main body unit includes an ejection unit including a nozzle surface in which a nozzle is open and being configured to eject a liquid from the nozzle, a maintenance unit configured to perform maintenance for the ejection unit, and a gutter through which a liquid flows from the maintenance unit, the mounting unit includes a reception tray configured to receive a liquid, and a distal end of the gutter overlaps with the reception tray as viewed in a vertical direction. According to the configuration described above, the liquid flows from the maintenance unit to the reception tray through the gutter. The liquid received onto the reception tray can be collected by detaching the mounting unit.
(G) The liquid ejection apparatus includes the accommodation device described above, wherein the main body unit includes an ejection unit including a nozzle surface in which a nozzle is open and being configured to eject a liquid from the nozzle, a maintenance unit configured to perform maintenance for the ejection unit, and a gutter through which a liquid flows from the maintenance unit, the mounting unit includes a reception tray configured to receive a liquid, and a distal end of the gutter overlaps with the reception tray as viewed in a vertical direction. According to the configuration described above, the liquid flows from the maintenance unit to the reception tray through the gutter. The liquid received onto the reception tray can be collected by detaching the mounting unit.
(H) In the liquid ejection apparatus described above, the gutter may be a first gutter, the main body unit may include a second gutter, the second gutter and the first gutted may be arrayed in the one direction in the stated order, the reception tray may include a reception wall configured to receive a liquid, a peripheral wall extending from a peripheral edge of the reception wall, and a projection wall extending in a direction different from the one direction and the vertical direction, from the peripheral wall, when the mounting unit at the first position is viewed in the vertical direction, a distal end of the first gutter may overlap with the projection wall, and, when the mounting unit at the first position is viewed in the vertical direction, a distal end of the second gutter may overlap with the reception wall. According to the configuration described above, when the mounting unit is displaced from the first position to the second position, the first gutter and the second gutter can easily be retracted. Thus, when the mounting unit is detached, a risk that the first gutter and the second gutter contact the reception tray is suppressed.
(I) In the liquid ejection apparatus described above, the gutter may be a first gutter, the main body unit may include a second gutter, the second gutter and the first gutted may be arrayed in the one direction in the stated order, the reception tray may include a reception wall configured to receive a liquid, a peripheral wall extending from a peripheral edge of the reception wall, and a projection wall extending in a direction different from the one direction and the vertical direction, from the peripheral wall, when the mounting unit at the first position is viewed in the vertical direction, a distal end of the first gutter may overlap with the projection wall, and, when the mounting unit at the first position is viewed in the vertical direction, a distal end of the second gutter may overlap with the reception wall. According to the configuration described above, when the mounting unit is displaced from the first position to the second position, the first gutter and the second gutter can easily be retracted. Thus, when the mounting unit is detached, a risk that the first gutter and the second gutter contact the reception tray is suppressed.

What is claimed is:

1. An accommodation device comprising:
a housing in which a mounting port is open;
a main body unit positioned in the housing;
a mounting unit mounted in the housing;
a coupling body coupled to the main body unit and the mounting unit; and
a contact unit configured to contact the mounting unit, wherein
the mounting unit is configured to move in one direction from an inside of the housing to an outside of the housing through the mounting port, and
the contact unit contacts the mounting unit when the mounting unit mounted in the housing moves in the one direction.

2. An accommodation device according to claim 1, wherein
the mounting unit includes a protruding portion that contacts the contact unit by moving in the one direction, and
the protruding portion is at a bottom of the mounting unit.

3. An accommodation device according to claim 1, wherein
while contacting with the contact unit, the mounting unit is at such a position that the coupling body is removable from at least one of the main body unit and the mounting unit.

4. An accommodation device according to claim 1, comprising:
a guide unit configured to guide the mounting unit when the mounting unit moves in the one direction, wherein,
the mounting unit includes a guide body that is guided by the guide unit,
the guide unit includes:
a restricting portion that restricts the mounting unit from moving upward when the mounting unit is at a first position; and
an allowing portion that allows the mounting unit to move upward when the mounting unit is at a second position,
the first position is a position at which the mounting unit is mounted in the housing,
the second position is a position at which the mounting unit contacts the contact unit, and
a vertical distance between the guide body and the allowing portion when the mounting unit is at the second position is larger than a vertical distance required for the mounting unit to overcome the contact unit.

5. An accommodation device according to claim 1, wherein
the contact unit includes a guide unit configured to guide the mounting unit when the mounting unit moves in the one direction,
the mounting unit includes a guide body that is guided by the guide unit,
the guide unit includes:
a restricting portion that restricts the mounting unit from moving upward when the mounting unit is at a first position; and
an allowing portion that allows the mounting unit to move upward when the mounting unit is at a second position,
the first position is a position at which the mounting unit is mounted in the housing,
the second position is a position at which the mounting unit contacts the contact unit, and
a vertical distance between the guide body and the allowing portion when the mounting unit is at the second position is larger than a vertical distance required for the mounting unit to overcome the contact unit.

6. A liquid ejection apparatus comprising:
the accommodation device according to claim 4, wherein
the main body unit includes:
an ejection unit including a nozzle surface in which a nozzle is open and being configured to eject a liquid from the nozzle;
a maintenance unit configured to perform maintenance for the ejection unit; and
a gutter through which a liquid flows from the maintenance unit,
the mounting unit includes a reception tray configured to receive a liquid, and
a distal end of the gutter overlaps with the reception tray as viewed in a vertical direction.

7. A liquid ejection apparatus comprising:
the accommodation device according to claim 5, wherein
the main body unit includes:
an ejection unit including a nozzle surface in which a nozzle is open and being configured to eject a liquid from the nozzle;
a maintenance unit configured to perform maintenance for the ejection unit; and
a gutter through which a liquid flows from the maintenance unit,
the mounting unit includes a reception tray configured to receive a liquid, and
a distal end of the gutter overlaps with the reception tray as viewed in a vertical direction.

8. A liquid ejection apparatus according to claim 6, wherein
the gutter is a first gutter,
the main body unit includes a second gutter,
the second gutter and the first gutted are arrayed in the one direction in the stated order,
the reception tray includes:
a reception wall configured to receive a liquid;
a peripheral wall extending from a peripheral edge of the reception wall; and
a projection wall extending in a direction different from the one direction and the vertical direction, from the peripheral wall,
when the mounting unit at the first position is viewed in the vertical direction, a distal end of the first gutter overlaps with the projection wall, and
when the mounting unit at the first position is viewed in the vertical direction, a distal end of the second gutter overlaps with the reception wall.

9. A liquid ejection apparatus according to claim 6, wherein
the gutter is a first gutter,
the main body unit includes a second gutter,
the second gutter and the first gutted are arrayed in the one direction in the stated order,
the reception tray includes:
a reception wall configured to receive a liquid;
a peripheral wall extending from a peripheral edge of the reception wall; and
a projection wall extending in a direction different from the one direction and the vertical direction, from the peripheral wall,
when the mounting unit at the first position is viewed in the vertical direction, a distal end of the first gutter overlaps with the projection wall, and
when the mounting unit at the first position is viewed in the vertical direction, a distal end of the second gutter overlaps with the reception wall.
